(19) United States
(12) Patent Application Publication
(10) Pub. No.: US 2008/0206518 A1
(43) Pub. Date: Aug. 28, 2008

(54) Method For Manufacturing Articles in the Form of Sheets Consisting of a Conglomerate Stone Material and Binder and Resultant Sheet

(76) Inventor: Luca Toncelli, Bassano Del Grappa (IT)

Correspondence Address: KATTEN MUCHIN ROSENMAN LLP, 575 MADISON AVENUE, NEW YORK, NY, 10022-2585, US

(21) Appl. No.: 11/997,440

(22) PCT Filed: Jun. 28, 2006
(86) PCT No.: PCT/EP2006/063636

§ 371 Date: Jan. 31, 2008

(30) Foreign Application Priority Data
Aug. 1, 2005 (IT) TV2005A000114

(51) Int. Cl. B29C 43/22; B32B 3/30

(52) U.S. Cl. 428/149; 264/70; 428/143

(57) ABSTRACT

A sheet of conglomerate material is formed with a visible surface having the form of so-called split stone or crocodile skin using a multiple mix consisting of at least two single mixes each formed by a granulated stone material and a hardening binder. At least one of the single mixes comprises a granular material having a hardness less than that of the granular material of the at least one other mix. When the sheet, vacuum vibrocompressed and hardened, is machined using a non-rigid abrasive tool, the surface zones (14) where the mix with the granular material of lesser hardness is present are scored to a greater degree, producing the aforementioned aesthetic effect. If, on the other hand, granules (26) of a material with a very high hardness are added to the mix, a sheet with non-slip properties is obtained.

The present invention relates to a method for manufacturing articles in the form of sheets, the visible surface of which has special qualities in terms of aesthetic effects and/or non-slip properties.

In relatively recent years technology for manufacturing articles in the form of sheets or blocks, consisting of a stone or stone-like conglomerate material, has been developed and has become established industrially, these articles being characterized by various advantageous properties, including the possibility of producing large blocks (size of about 3.1×1.4×0.9 metres) to be sawn into sheets or directly sheets with large dimensions (of about 3.2×1.6 metres) and a relatively small thickness (a few centimetres), such that they are suitable for forming internal and external flooring and cladding of buildings as well as furnishing components.

Secondly these articles have a notable uniformity in terms of external appearance, in particular of the surface which is intended to remain visible, these properties being difficult to obtain in the case of sheets obtained by means of sawing from blocks of natural stone (such as marble, granite, porphyry, etc.).

Thirdly these conglomerate articles may be made from surplus crushed stone material, namely material which would otherwise remain unused after the operations involving extraction of blocks of stone material from the quarries, with an obvious advantage not only from the point of view of the costs of the raw materials but also as regards environmental impact.

The technology in question envisages essentially:

(a) preparation of an initial mix consisting mainly of one or more stone or stone-like granular materials, said granular materials having a selected particle size, and a binder;

(b) deposition of a layer of predefined thickness of this mix on a temporary support surface and subsequent covering of the mix with a similar support, or in a mould;

(c) a vacuum vibrocompression step, during which the layer of mix undergoes the action of a press in an environment in which a predefined vacuum has been formed and at the same time a vibratory movement of predefined frequency is applied to the layer;

(d) a final step involving hardening of the resultant rough-formed article, the procedures for this step depending mainly on the nature of the binder.

In the technologies in question it is possible to use an inorganic binder, in particular of the cement-based type, in which case the hardening step is performed using the procedures which are typical of cement-based articles.

Alternatively, it is possible to use a binder consisting of an organic hardening resin, in which case hardening of the rough-formed sheet is performed using techniques which are well-known for synthetic resins, usually by means of the combined action of a catalyst agent and an accelerator with possible application of heat.

For more detailed information regarding these processes and plants for producing both types of sheet-like articles reference should be made to the following documents: European patent No. 786,325 and 1,027,205 relating to the use of organic binders, Italian patent application No. TV2004000103 relating to inorganic binders, and Italian patent No. 1,181,570 (mixing of the initial mix).

Italian patent No. 1,242,777 in turn describes a method and an apparatus for preparing mixes of stone or ceramic material aggregates, involving in particular the combination of at least two base mixes which are different from each other owing to the nature of the aggregate contained in the mix and/or the colouring thereof before they are fed to the abovementioned support or to a formwork for the vacuum vibrocompression step.

Specifically the two or more mixes are deposited in the form of layers in points of an annular rotating container, situated at a distance from each other. The speed imparted to the annular container is such that the mixes, as they fall onto the ring, form layers which are arranged on top of each other.

Preferably rotating vanes or fixed blades are used for a homogenizing action and optimum composition of the layers deposited in succession, following which the resultant final mix is transferred to the vibrocompression step.

All this technology is aimed in particular at the production of articles in the form of sheets which resemble as far as possible natural stone material, said material, in the case of granite, having varying colours and in particular a characteristic aggregated crystal appearance. In fact, when observing a sheet of granite, especially a finished and hence smoothed and polished sheet, it can be noted how it very often has three or often more components with a different colour and size.

With the development of the possible applications it has been necessary to use various mixes, namely which are more than three in number, but which must be combined with each other so as to have the same intermixing characteristics mentioned above.

In this case it is possible to use both the method and the plant according to the already mentioned Italian patent No. 1,242,777 and those forming the subject of the Italian patent application No. TV2005A000106 in the name of the same Applicant, filed on 18 Jul. 2005.

The technical problem to which the present invention specifically relates is that of modifying the form of the visible surface or side of the final sheet, the visible side being understood as meaning the surface of the sheet intended to remain visible after laying.

Hitherto, with the abovementioned available techniques, it has been possible to improve the aesthetic appearance of the visible—in any case planar—surface of the sheets, as regards reproduction, in the horizontal plane, of the characteristic appearance of original natural stone.

However, as is well-known to persons skilled in the art, during the machining of natural stone and in particular following brushing or graining, it is possible to obtain so-called three-dimensional effects in the sense that the visible surface or side has slight depressions and parts which are slightly raised to a more or less pronounced degree and which greatly influence the final aesthetic appearance of the sheet, especially after laying.

A very widespread but as yet not entirely fulfilled requirement is also that of reducing the natural slipperiness of sheets intended to form a floor, ensuring at the same time a sufficiently shiny surface.

Hitherto, in order to achieve this result, use has been made of externally mounted parts with a greater slip-resistance (such as strips of non-slip material applied to the surface of the sheet), or simply the surface of the sheet is smoothed, but without mirror-polishing it.

It has now been found—and this forms the subject of the present invention—that if the sheet-like article is made from a multiple final mix comprising at least two single mixes, one of which has overall a different hardness compared to the other mix, and the hardened rough-formed sheet undergoes surface machining using non-rigid abrasive tools, in particular having a plurality of abrasive bristles or stubs, the mix with a lesser hardness is scored more than the at least one other mix with a greater hardness.

In other words, when the resultant sheet is obtained from two or more single mixes, at least one of which has a hardness less than that of the other mix or mixes, the use of a “soft” abrasive tool (namely of the type with abrasive parts consisting of bristles or stubs with abrasive protuberances) produces in the resultant surface or visible side zones having scoring of varying depth, this depth being more pronounced where the mix with a lesser hardness is present on the surface. The latter resembles the surface appearance of so-called split stone or, in a different sector, the surface structure of crocodile skin.

If, on the other hand, the mix with a greater hardness, where the surface has raised areas, incorporates in turn particles or granules with a very great hardness, greater than the hardness of the granular materials forming all the single mixes of the said multiple mix, after the smoothing operation these particles or granules project from the visible side of the sheet, so that the tread surface of the sheet (consisting precisely of the visible side) has a roughness such as to ensure the desired non-slip effect.

The aspects and specific advantages of the present invention will emerge more clearly from the detailed description which follows with reference to the accompanying drawings in which:

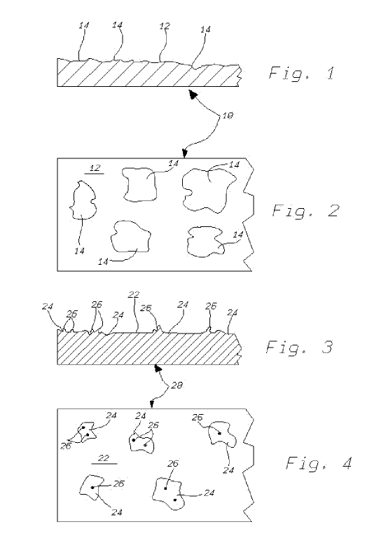

FIGS. 1 and 2 show a first embodiment of a sheet according to the invention, in a cross-sectioned and partially plan view;

FIGS. 3 and 4 are views similar to those of FIGS. 1 and 2, but show a second embodiment of the sheet.

As already mentioned, the manufacture of sheets according to the invention is performed using the technology mentioned in the initial part of the present description, by preparing a multiple mix which consists of at least two single mixes, one of which is formed with a granular material having a hardness less than that of the granular material forming the other mix or mixes.

Each single mix is prepared, in a manner known per se, by mixing a granular stone or stone-like material of selected particle size with a hardening binding resin or with a water-based binder such as Portland cement.

The mix normally also comprises a filler or reinforcing material in addition to other possible additives, for example in relation to the catalytic hardening of the resin or fluidification of the cement binder.

Marble, granite, quartz, feldspar, etc. are normally chosen as natural stone granular materials.

The granular material has a selected particle size with dimensions normally in the following ranges (expressed in mm): 0.1-0.3; 0.1-0.7; 0.1-1.2; 0.2-2.25; 0.1-4.0 and 0.1-6.0.

The hardness of the natural stone granular materials mainly suitable for use is as follows:

| | | |
|---|---|---|
| Marble | 4-5 | Mohs |
| Feldspar | 6 | Mohs |
| Granite | 6-7 | Mohs |
| Quartz | 7 | Mohs |

Therefore combinations are possible where one of the two mixes is marble-based, while the other mix may be equally well based on granulated feldspar, granite or quartz.

In turn, the feldspar may be used for the mix of lesser hardness in combination with another granite or quartz-based mix.

In addition to the aesthetic aspect, other factors or physical properties may also play a part in the choice of the component granular materials; for example, if two mixes based on feldspar and granite or quartz are used, acid-resistant articles are obtained.

In the simplest case, namely that of only two single mixes forming a multiple mix, each of the two mixes may have a similar formulation, which can be related to the desired particle-size range, preferably using Bolomey's formula.

An example of such similar formulations, for a particular particle-size range, chosen from among those indicated above, is as follows, expressed in percentages by volume:

| | |
|---|---|
| Polyester resin | 22% |
| Filler 25,000 mg/cm² | 25% |
| Granular material 0.1-0.3 mm | 53% |

A second example of such similar formulations, for a different particle-size range, chosen from among those indicated above, is as follows, expressed in percentages by volume:

| | |
|---|---|
| Polyester resin | 18% |
| Filler 25,000 mg/cm² | 22% |
| Granular material 0.1-1.2 mm | 60% |

In both the examples the particle size included within the range indicated consists of quantities determined using Bolomey's formula.

Let us consider, by way of a non-limiting example, a sheet manufactured using two mixes, one of which has the composition indicated in the first of the formulation examples given and is made using feldspar, while the other mix has the composition indicated in the second of the formulation examples and uses quartz as the granular material. If the sheet undergoes surface machining using a series of brush-type abrasive tools, the filaments of which consist of abrasive bristles or stubs of varying and decreasing particle size (for example of the commercially available type consisting of nylon filaments on the surface of which diamond granules of selected particle size are partially embedded), a final article having the configuration shown in FIGS. 1 and 2 is obtained.

In these figures the reference number 10 indicates the sheet with a visible side 12, composed of the two mixes indicated above, the quartz-based one of which forms the raised surface areas, while the feldspar-based mix is present in the lower areas indicated by 14.

From FIG. 1 it can be seen how, owing to the more penetrating abrasive action in the zones where the mix of lesser hardness is present, the surface has recesses or depressions 14 about 0.5-2 mm deep.

In accordance with a second embodiment, the single mix formed with granular material of greater hardness, forming the raised zones, incorporates granules of material which are extremely hard, such as, for example, corundum or silicon carbide (hardness of about 9 Mohs).

In this case the surface machining operation performed with the previously mentioned abrasive tools results in a visible surface of the final sheet where, in the raised zones, the tips of the granules of very hard material protrude, the abrasive tools having removed the harder mix from around them.

In this way a sheet which ensures an effective non-slip action is obtained since, when trodden on, supporting is obviously provided by the raised zones from where the granules of very hard material protrude.

FIGS. 3 and 4 illustrate this embodiment. In this case, the sheet is indicated generally by the reference number 20 and has on its visible surface 22 exposed areas, indicated by the reference number 24, formed by a mix of material harder than that forming the remainder of the surface 22. Inside the areas 24, the reference number 26 indicates granules of very hard material (for example of the type mentioned above) which project from the surface 22 by the amount sufficient to achieve the desired non-slip action.

0.5-1.5% by volume of granules of very hard material with a particle size ranging from 0.7 to 1.2 mm, preferably corundum or silicon carbide, is added to the single harder starting mix, for example consisting of quartz with a particle size of up to 0.7 or up to 1.2 mm.

Within the context of this embodiment, the use of two mixes is advisable when it is desired to obtain a sheet with an irregular surface form having areas which are more or less scored, because in this case the inclusion of granules of very hard material is performed in the mix formed with harder granules (such as granite or quartz) which form the raised surface areas.

If, on the other hand, it is desired to form a sheet with a uniform surface, then two separate mixes are not necessary, but it is sufficient to include the granules of very hard material in the single mix which therefore also comprises granules of stone material, such as, for example, marble or feldspar, with a hardness less than that of the material with a very high hardness factor.

From the above description it clearly emerges that previously mentioned advantages are achieved with the method of the invention.

Variations and modifications which are conceptually and mechanically equivalent are nevertheless possible and may be envisaged within the scope of protection of the following claims.

For example the same technology may be used for the manufacture of articles in the form of blocks, except that sawing of the blocks into sheets must be performed before performing smoothing using the tools with flexible abrasive bristles.

1.-14. (canceled)

15. Method for manufacturing articles in the form of sheets, of the type which envisages the steps of:
(a) preparation of a multiple final mix formed from a first and at least a second single mix, each of which comprises one or more stone or stone-like granular materials having a selected particle size and a binder, the first of said single mixes having a hardness lower than the at least one second single mix;
(b) deposition of a layer of predefined thickness of this multiple mix on a temporary support surface and subsequent covering of the mix with a similar support or in a mould;
(c) a vacuum vibrocompression step, during which the mix undergoes the action of a press in an environment in which a predefined vacuum has been formed and at the same time a vibratory movement of predefined frequency is applied to the layer, leading to a rough-formed article;
(d) a final step involving hardening of the resultant rough-formed article, characterized in that the resultant hardened rough-formed sheet undergoes surface machining using non-rigid abrasive tools comprising bristles or stubs in which are partially embedded granules of a material having a hardness higher than any of the granular materials comprised in the multiple mix, the said machining providing a sheet having on its visible surface zones having scoring of varying depth.

16. Method according to claim 15, characterized in that the granular material of said first single mix is chosen from marble and feldspar and in that the granular material of said at least one other single mix is chosen from granite and quartz.

17. Method according to claim 15, characterized in that the granular material of said first single mix is marble and the granular material of said at least one other single mix is chosen from among feldspar, granite and quartz.

18. Method according to claim 15, characterized in that granules of material with a hardness greater than the hardness of the granular materials comprised in all of the said single mixes of the said multiple mix, are incorporated in said at least one second mix and the surface machining leads to a surface of the sheet of a roughness ensuring a non-slip effect.

19. Method according to claim 18, characterized in that said material with a highest hardness is preferably chosen from corundum and silicon carbide.

20. Method according to claim 18, characterized in that said material with a highest hardness is present in a quantity equal to 0.5-1.5% by volume in relation to the volume of the corresponding single mix.

21. Method according to claim 15, characterized in that, instead of being deposited on a temporary support surface or in a mould, said multiple mix is fed into a formwork so as to form a block which, after the vibrocompression and hardening steps, undergoes sawing into sheets on which said surface machining step using non-rigid abrasive tools is performed.

22. Sheet obtained from a multiple mix comprised of a first and at least one second single mix of granular stone materials and binders, in which the surface intended to remain visible is provided with zones scoring of varying depth, characterized in that said scoring corresponds to areas where is present a first single mix comprising a granular material having a hardness lower than the granular material of the at least one second single mix.

23. Sheet according to claim 22, which can be obtained with the method of:
(a) preparation of a multiple final mix formed from a first and at least a second single mix, each of which comprises one or more stone or stone-like granular materials having a selected particle size and a binder, the first of said single mixes having a hardness lower than the at least one second single mix;
(b) deposition of a layer of predefined thickness of this multiple mix on a temporary support surface and subsequent covering of the mix with a similar support or in a mould;
(c) a vacuum vibrocompression step, during which the mix undergoes the action of a press in an environment in which a predefined vacuum has been formed and at the same time a vibratory movement of predefined frequency is applied to the layer, leading to a rough-formed article;
(d) a final step involving hardening of the resultant rough-formed article,
characterized in that the resultant hardened rough-formed sheet undergoes surface machining using non-rigid abrasive tools comprising bristles or stubs in which are partially embedded granules of a material having a hardness higher than any of the granular materials comprised in the multiple mix, the said machining providing a sheet having on its visible surface zones having scoring of varying depth.

24. Sheet characterized in that granules of material with a hardness greater than the hardness of the granular materials comprised in all of the said single mixes of the said multiple mix, are incorporated in said at least one second mix and the surface machining leads to a surface of the sheet of a roughness ensuring a non-slip effect,
from a multiple mix in which granules of material with a hardness higher than any other granular material in the multiple mix are comprised in said at least one second single mix and are protruding from the surface of the sheet which is intended to remain visible so that the surface has a roughness ensuring a non-slip effect.

25. Sheet according to claim 24, characterized in that said material with a highest hardness is chosen from corundum and silicon carbide.
